(19) United States
(12) Patent Application Publication
(10) Pub. No.: US 2005/0120886 A1
(43) Pub. Date: Jun. 9, 2005

(54) Infusion tea maker

(76) Inventor: Shao-Wen Chen, Pingjhen City (TW)

Correspondence Address: TROXELL LAW OFFICE PLLC, SUITE 1404, 5205 LEESBURG PIKE, FALLS CHURCH, VA, 22041, US

(21) Appl. No.: 10/958,359

(22) Filed: Oct. 6, 2004

(30) Foreign Application Priority Data
Dec. 3, 2003 (TW) 092221320

(51) Int. Cl. A23F 3/00

(52) U.S. Cl. 99/279

(57) ABSTRACT

An infusion tea maker is disclosed to include a jug, a brewing basket, which is supported inside the hug and has a top brewing chamber, a bottom air chamber, and a center guide tube vertically downwardly extended from the top infusion chamber through the bottom air chamber to the outside of the brewing basket, a rotary knob for regulating flow rate of infused tea out of the center guide tube to the inside space of the jug, and a cover, which is covered on the jug and attracts the brewing basket by magnetic attraction.

### BACKGROUND OF THE INVENTION

1. Field of the Invention

The present invention relates to a tea maker and more particularly, to an infusion tea maker, which enables the user to adjust the infusion time subject to one's taste preference and, which has means to separate infused tea leaves from infused tea.

2. Description of the Related Art

FIG. 1 shows an infusion tea maker according to the prior art. According to this design, the infusion tea maker A comprises a detachable filter assembly A1. The filter assembly A1 has a top flange A11 supportable on the rim of the jug of the infusion tea maker A. When in use, a suitable amount of tea leaves T is put in the filter assembly A1, and then hot water is poured through the filter assembly A1 into the inside of the infusion tea maker A. A certain length of time after infusion, the user must remove the filter assembly A1 out of the infusion tea maker A because over-infusion results in bitter taste of infused tea. However, it is not hygienic to take the filter assembly A1 out of the infusion tea maker A directly with the hand. Further, when removing the filter assembly A1 from the infusion tea maker A, the hot filter assembly A1 may scald the user's hand.

FIG. 2 shows another structure of infusion tea maker according to the prior art. According to this design, the infusion tea maker B comprises a jug B1, a cover B4 capped on the jug B1, a rod B2, which has a top end inserted through the cover B4 and fixedly fastened with a knob B21, and a filter assembly B3 affixed to the bottom end of the rod B2. When in use, a suitable amount of tealeaves T is put in the filter assembly B3, and then hot water is poured through the filter assembly B3 to the bottom space inside the jug B1. This design of infusion tea maker cannot separate tealeaves from infused tea. Further, when tealeaves are infused for a certain length of time, the tealeaves will release theophylline that is harmful to the health.

### SUMMARY OF THE INVENTION

The present invention has been accomplished under the circumstances in view. According to one aspect of the present invention, the infusion tea maker comprises a jug, the jug comprising an inside annular flange; a brewing basket supportable on the inside annular flange inside the jug, the brewing basket comprising a top brewing chamber, a bottom air chamber, a center guide tube vertically downwardly extended from the top infusion chamber through the bottom air chamber to the outside of the brewing basket, and a top flange supportable on the inside annular flange inside the jug; and a cover for covering the jug; wherein when pouring hot water into the brewing basket inside the jug to infusion tea leaves in the top brewing chamber into infused tea, the bottom air chamber produces a buoyancy to lift the brewing basket in water inside the jug, for enabling infused tea to flow through the center guide tube to the outside of the brewing basket into the holding space of the jug. According to another aspect of the present invention, the

A flow rate regulation means is installed in the bottom side of the center guide tube of the brewing basket for regulating the flow rate of infused tea passing out of the center guide tube. The flow rate regulation means comprises a rotary knob rotatably coupled to a bottom end of the center guide tube in vertical, the rotary knob having a water outlet corresponding to an opening in the bottom end of the center guide tube.

### BRIEF DESCRIPTION OF THE DRAWINGS

FIG. 1 is a schematic drawing showing the use of an infusion tea maker according to the prior art.

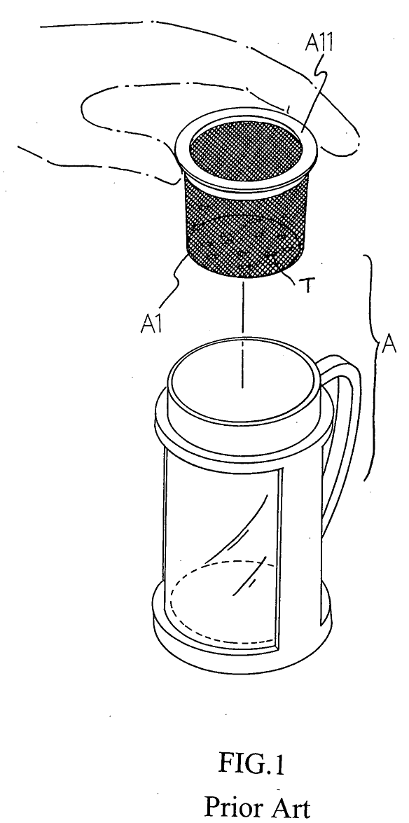

FIG. 2 is a perspective view of another structure of infusion tea maker according to the prior art.

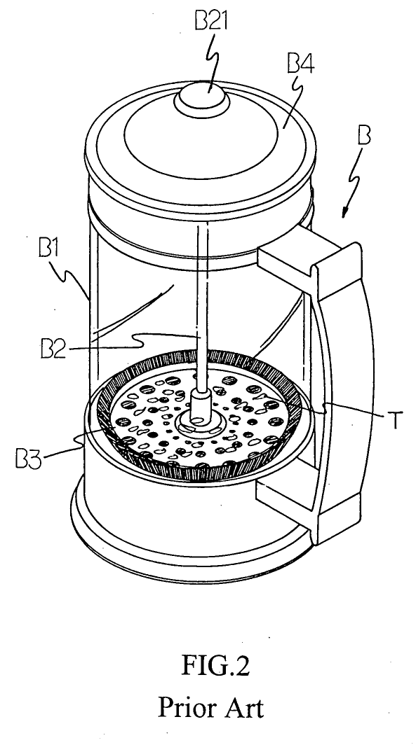

FIG. 3 is an elevational view of an infusion tea maker according to the present invention.

FIG. 4 is an exploded view of the infusion tea maker according to the present invention.

FIG. 5 is a schematic drawing showing hot water poured through the perforated spreader into the brewing basket inside the jug of the infusion tea maker according to the present invention.

FIG. 6 is a schematic drawing showing the user lifted the cover and the brewing basket out of the jug according to the present invention.

FIG. 7 is a sectional view in an enlarged scale of a part of the infusion tea maker according to the present invention.

FIG. 8 is an exploded view of an alternate form of the infusion tea maker according to the present invention.

FIG. 9 is a schematic drawing showing an use of the infusion tea maker of FIG. 8.

FIG. 10A is a schematic drawing showing the rotary knob of the infusion tea maker adjusted to one position according to the present invention.

FIG. 10B is a schematic drawing showing the rotary knob of the infusion tea maker adjusted to another position according to the present invention.

FIG. 11 is a perspective view showing an alternate form of the rotary knob installed in the center guide tube of the brewing basket according to the present invention.

### DETAILED DESCRIPTION OF THE INVENTION

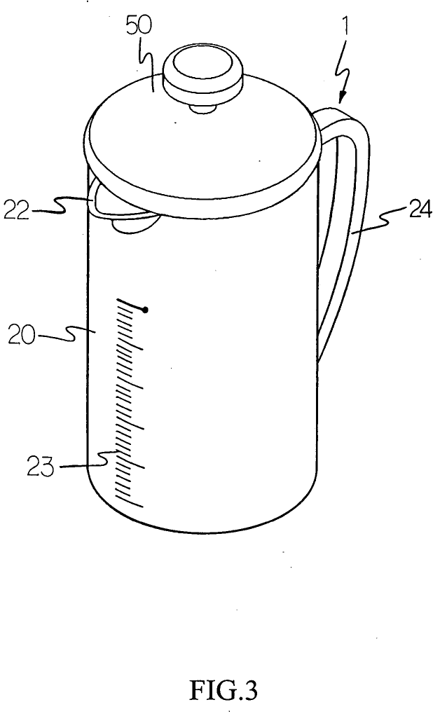

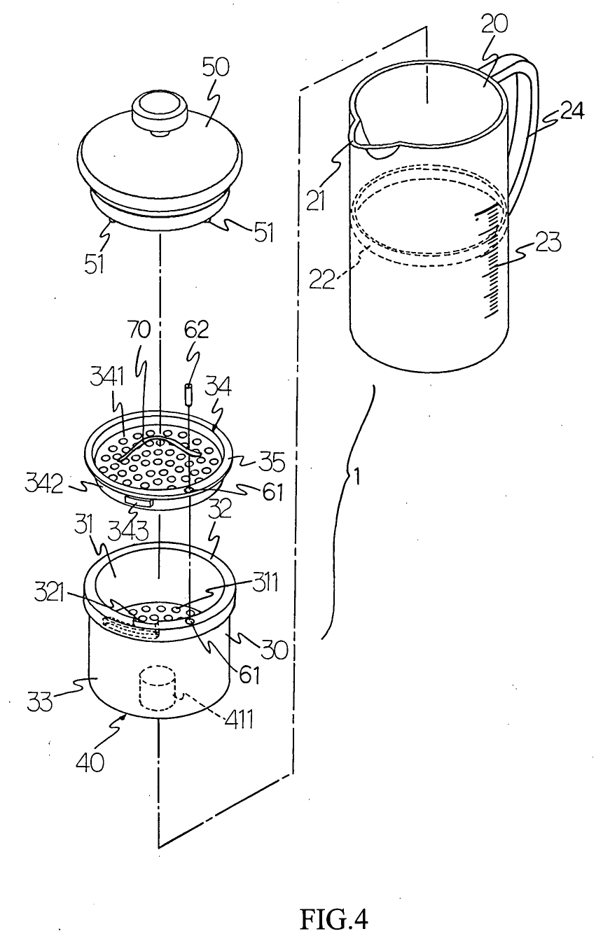

Referring to FIGS. 3 and 4, an infusion tea maker 1 in accordance with the present invention is shown comprised of jug 20, a brewing basket 30, a flow guide 40, and a cover 50.

The jug 20 has an annular inside flange 22 adapted to support the brewing basket 40 inside the hub 20, a spout 21 through which infused tea is poured out of the jug 20, a scale 23 marked on the periphery in vertical for volume measurement, and a handle 24 at a suitable location.

The brewing basket 30 is covered with a perforated spreader 34, having a top brewing chamber 31, a bottom air chamber 33, a filter 311 mounted in between the top brewing chamber 31 and the bottom air chamber 33, and a top locating hole 321. The perforated spreader 34 has a perforated base 341, a peripheral wall 342 fitting the diameter of the top brewing chamber 31, a locating rod 343 for engaging into the locating hole 321, and a top flange covered with a metal plate 35. The perforated spreader 34 is equipped with a handle 70 through which the user can easily remote the perforated spreader 34 from the brewing basket 30.

The flow guide 40 comprises a center guide tube 41 downwardly extended from the bottom side of the top brewing chamber 31 to the bottom side of the bottom air chamber 33, having a bottom protruding portion 411 extended out of the bottom side of the brewing basket 30.

The cover 50 is covered on the jug 20, having a plurality of magnets 51 equiangularly spaced around the bottom side for attracting the metal plate 35 of the perforated spreader 34.

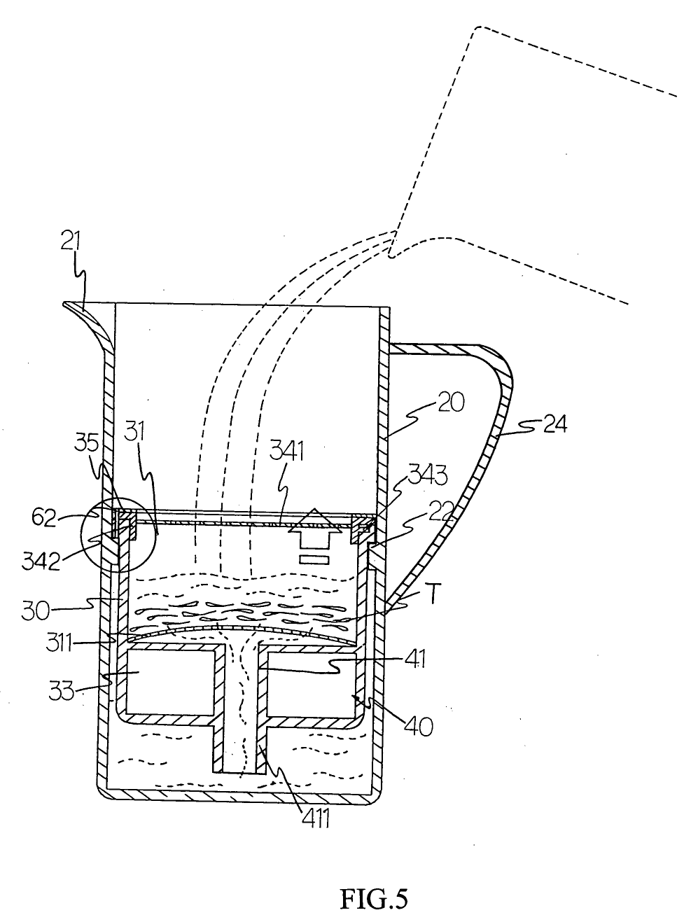

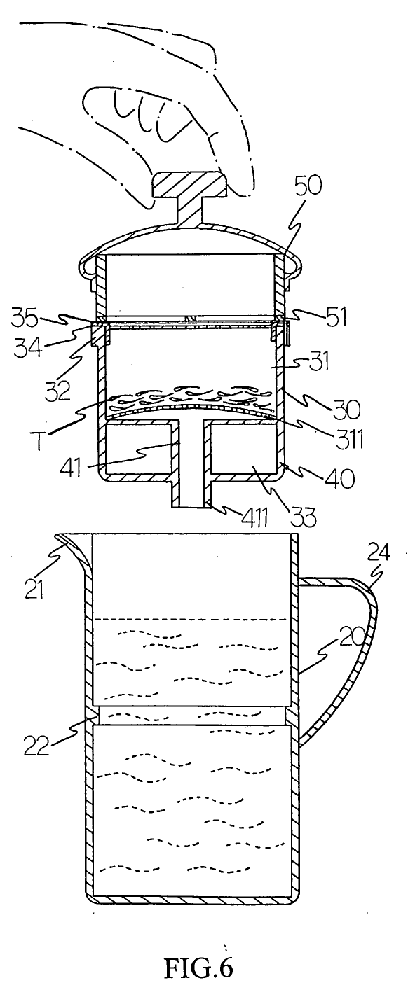

Referring to FIGS. 5 and 6, when in use, tea leaves T is put in the top brewing chamber 31, and then the perforated spreader 34 is covered on the brewing basket 30, and then hot water is poured through the perforated spreader 34 into the brewing basket 30 inside the jug 20, and then the cover 50 is covered on the jug 20. At this time, the water pressure in the brewing basket 30 forces the brewing basket 30 downwards, thereby causing the top flange 32 firmly pressed on the inside annular step 22 to stop water from passing through the gap between the inner diameter of the jug 20 and the outer diameter of the brewing basket 30. At this time, only a small amount of infused tea passes through the center guide tube 41 to the jug 20. When hot water level reaches the elevation of the top flange 32 of the brewing basket 30, the air inside the bottom air chamber 33 is caused to expand due to hot, thereby causing the brewing basket 30 to float in hot water and to let infused tea pass out of the center guide tube 41 to the inside space of the hug 20. At this time, the user can lift the cover 50 to carry the brewing basket 30 out of the jug 20.

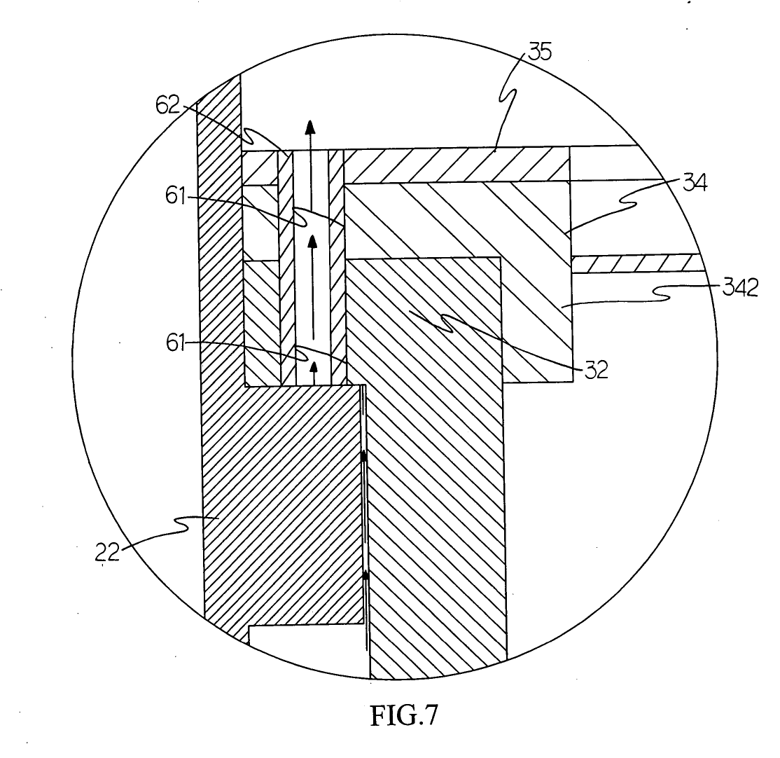

Referring to FIG. 7 and FIGS. 4 and 7 again, an air tube 62 is fitted into respective air holes 61 in the perforated spreader 34 and the top flange 32 of the brewing basket 30 for enabling excessive air to pass out of the space between the jug 20 and the brewing basket 30.

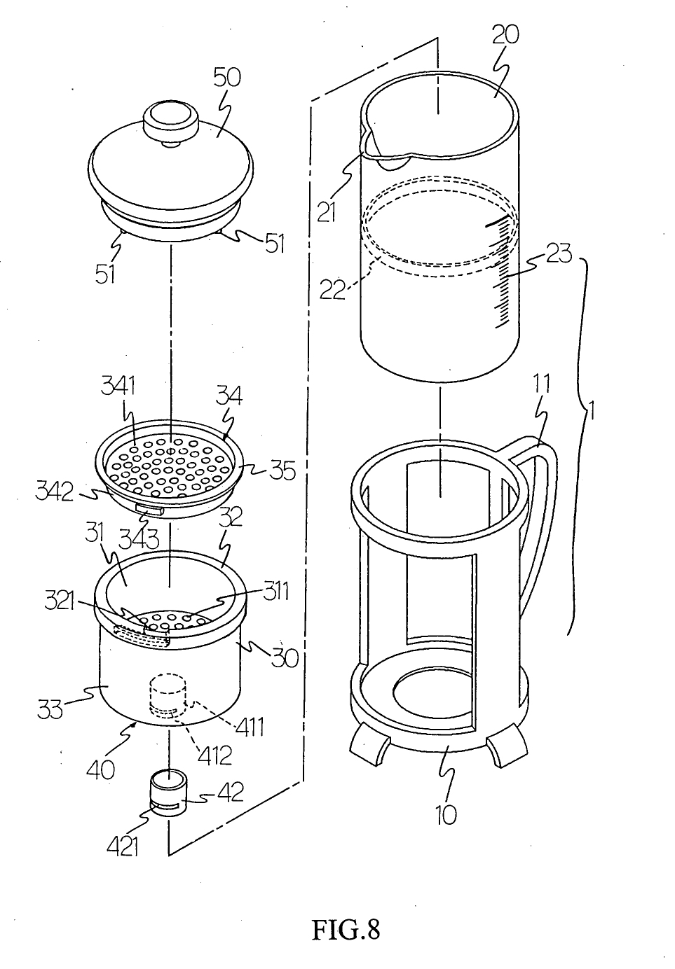

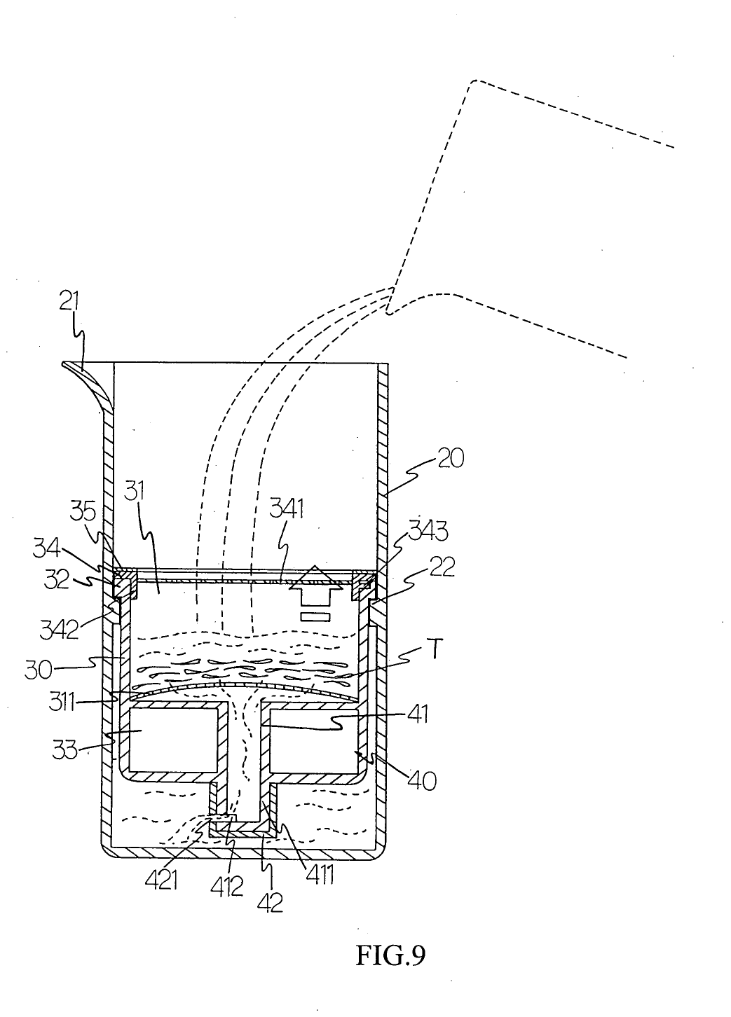

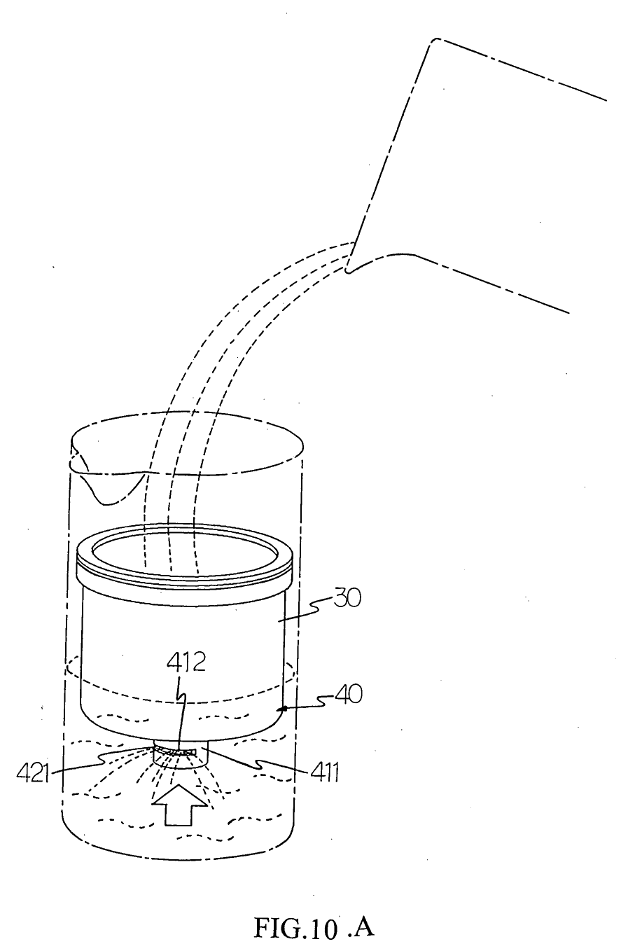

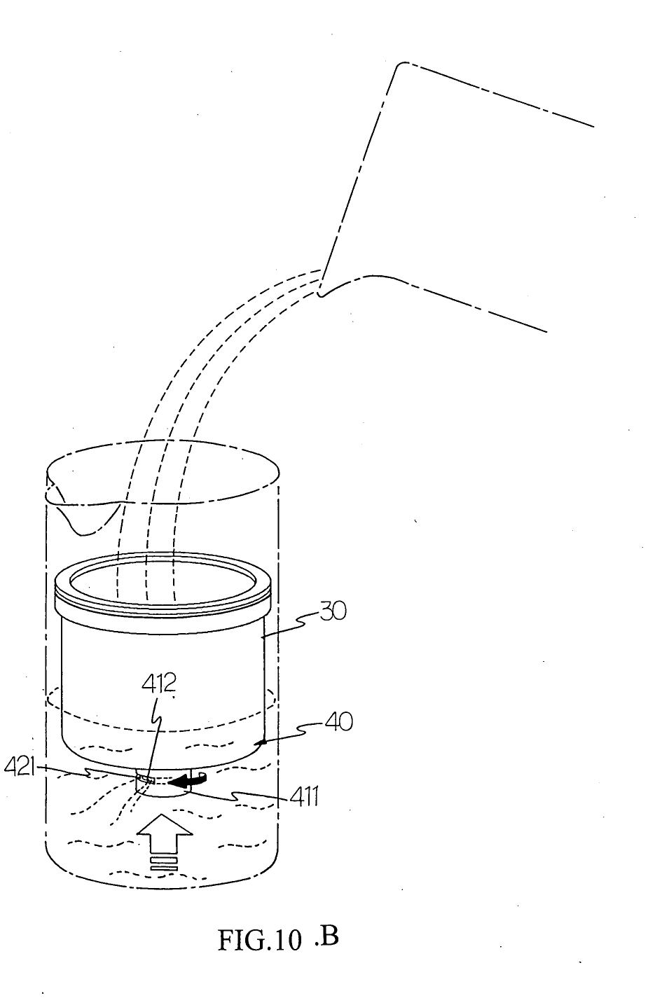

FIGS. 8-10 show an alternate form of the present invention. According to this embodiment, the bottom protruding portion 411 has an opening 412; a rotary knob 42 is rotatably coupled to the bottom protruding portion 411 in vertical, having a water outlet 421 corresponding to the opening 412. The user can rotate the rotary knob 42 to adjust the flow rate of water through the passage formed of the opening 412 and the water outlet 421. FIG. 10A shows the passage formed of the opening 412 and the water outlet 421 adjusted to a high flow rate status. At this time, hot water passes through the brewing basket 30 to the inside space of the jug 20 at a relatively high speed, and the tea infusion time is relatively shortened. FIG. 10B shows the passage formed of the opening 412 and the water outlet 421 adjusted to a low flow rate status. At this time, hot water passes through the brewing basket 30 to the inside space of the jug 20 at a relatively low speed, and the tea infusion time is relatively extended.

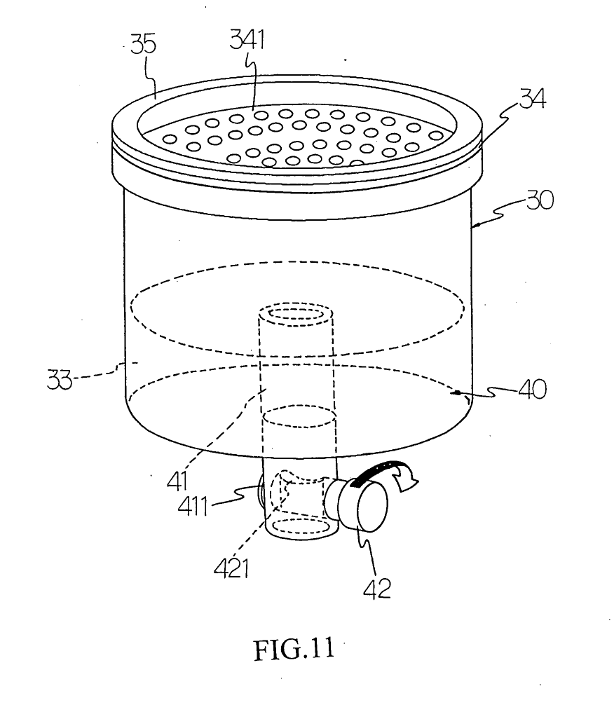

FIG. 11 shows another alternate form of the present invention. According to this embodiment, the rotary knob 42 is installed in the bottom protruding portion 411 in a horizontal position. This embodiment achieves the same effect as the embodiment shown in FIGS. 8-10.

Referring to FIG. 8 again the infusion tea maker 1 may be used with an infusion tea maker holder 10. The infusion tea maker holder 10 holds the infusion tea maker 1 on the inside, having a handle 11 for the holding of the user's hand to prevent direct tough of the user's hand with the hot infusion tea maker 1.

A prototype of infusion tea maker has been constructed with the features of FIGS. 3˜1. The infusion tea maker functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. An infusion tea maker comprising:
a jug, said jug comprising an inside annular flange;
a brewing basket supportable on said inside annular flange inside said jug, said brewing basket comprising a top brewing chamber, a bottom air chamber, a center guide tube vertically downwardly extended from said top infusion chamber through said bottom air chamber to the outside of said brewing basket, and a top flange supportable on said inside annular flange inside said jug; and
a cover for covering said jug;
wherein when pouring hot water into said brewing basket inside said jug to infusion tea leaves in said top brewing chamber into infused tea, said bottom air chamber produces a buoyancy to lift said brewing basket in water inside said jug, for enabling infused tea to flow through said center guide tube to the outside of said brewing basket into the holding space of said jug.

2. The infusion tea maker as claimed in claim 1, wherein further comprising flow rate regulation means adapted to control the flow rate of infused tea passing out of said center guide tube.

3. The infusion tea maker as claimed in claim 1, wherein said brewing basket is covered with a perforated spreader, said perforated spreader having a locating rod engaged into a locating hole in said brewing basket and a metal plate covered on a top flange thereof.

4. The infusion tea maker as claimed in claim 1, wherein said cover has a plurality of magnets provided at a bottom side thereof and adapted to attract said brewing basket by means of magnetic attraction.

5. The infusion tea maker as claimed in claim 1, wherein said brewing basket comprises a filter that separates said bottom air chamber from said top brewing chamber.

6. The infusion tea maker as claimed in claim 1, wherein said jug has a handle.

7. The infusion tea maker as claimed in claim 1, further comprising an infusion tea maker holder adapted to hold said jug, said infusion tea maker holder having a handle.

8. The infusion tea maker as claimed in claim 1, wherein said brewing basket is covered with a perforated spreader, said perforated spreader having at least one air hole respectively connected to respective air hole in the top flange of said brewing basket by a respective air tube.

9. The infusion tea maker as claimed in claim 2, wherein said flow rate regulation means comprises a rotary knob rotatably coupled to a bottom end of said center guide tube in vertical, said rotary knob having a water outlet corresponding to an opening in the bottom end of said center guide tube.

10. The infusion tea maker as claimed in claim 2, wherein said flow rate regulation means comprises a rotary knob rotatably coupled to a bottom end of said center guide tube in horizontal, said rotary knob having a water outlet corresponding to an opening in the bottom end of said center guide tube.
